(19) United States
(12) Patent Application Publication
(10) Pub. No.: US 2010/0296820 A1
(43) Pub. Date: Nov. 25, 2010

(54) FREE SPACE OPTICAL INTERCONNECT

(76) Inventors: Huei Pei Kuo, Cupertino, CA (US); Robert G. Walmsley, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/864,231

(22) PCT Filed: Jan. 31, 2008
(86) PCT No.: PCT/US08/01437

§ 371 Date: Jul. 22, 2010

(51) Int. Cl. H04B 10/12

(52) U.S. Cl. 398/201

(57) ABSTRACT

A system such as a server (100) dynamically aligns multiple free-space optical communication signals. One system embodiment includes a first array (114) in a first subsystem (110) and a second array (116) in a second subsystem (110). The first array (114) contains transmitters that produce optical signals that are transmitted through a first lens (220), free space, and a second lens (270) to the second array (116). The second array (116) contains receivers, and the first and second lenses (220, 270) constitute a telecentric lens that forms an image of the first array (114) on the second array (116). Mounting systems (230, 280) attach the first and second lenses (220, 270) respectively to the first and second subsystems (110), and at least one of the mounting systems (230, 280) dynamically moves the attached lens (220, 270) or another optical element (210, 260) to maintain image alignment.

### BACKGROUND

High data rate signal transmission is a concern in many systems. Current server systems, for example, often use a set of user-selected components that need to communicate with each other at high data rates. In a server system using blades, for example, the blades, e.g., server blades and storage blades, are mounted in a common enclosure and share system components such as cooling fans, power supplies, and enclosure management. For the blades to work together and provide the desired data storage, processing, and communications, the server system needs to provide high data rate communication channels for communications between blades.

Data channels using electrical signaling generally require high frequency electrical signals to provide high data transmission rates, and the high frequency oscillations can present impedance and noise problems for electrical signals transmitted over conductors such as copper wires. Data channels using optical signaling can avoid many of these problems, but guided optical signaling may require complex waveguides and/or dealing with loose optical cables or ribbons. The optical cables or ribbons may introduce space and reliability issues in systems such as servers. Free-space optical signaling avoids impedance and noise problems associated with electrical signals and avoids the need for waveguides or optical cables. However, use of a free-space optical data channel in a system such as a server generally requires the ability to precisely align an optical transmitter and an optical receiver and the ability to maintain the alignment in an environment that may experience mechanical vibrations and thermal variations. The challenges of establishing and maintaining alignment for free-space optical data channels can multiply when multiple data optical channels are needed. Accordingly, systems and methods for economically and efficiently establishing and maintaining multiple free-space optical channels are desired.

### SUMMARY

In accordance with an aspect of the invention, an optical system can align and provide multiple free-space optical signals for data communications. One embodiment of the system includes a first array in a first subsystem and a second array in a second subsystem. The first array contains transmitters that respectively produce optical signals that are transmitted through a first lens, free space, and a second lens to reach the second array in the second subsystem. The second array contains receivers respectively corresponding to the optical signals, and the first lens and the second lens together constitute a telecentric lens that forms an image of the first array on the second array. First and second mounting systems respectively attach the first and second lenses to the first and second subsystems, and at least one of the mounting systems dynamically moves the attached lens or another optical element to maintain the image of the first array in an aligned position on the second array.

### BRIEF DESCRIPTION OF THE DRAWINGS

FIG. 1 shows a server system in accordance with an embodiment of the invention employing alignment-tolerant free-space data channels for communications among system planes or blades.

FIG. 2 illustrates a system employing multiple parallel optical communication channels with shared collimation and alignment systems.

FIGS. 3A and 3B illustrate how tilting an optical plate shifts beams.

FIGS. 4A, 4B, 4C, and 4D illustrate the movements of an image that result from movement or misalignment of lenses that form a telecentric lens.

FIG. 5 is a plan view of a receiver array in accordance with an embodiment of the invention.

FIG. 6 is a cross-sectional view of a server system using multi-channel optical communications in accordance with an embodiment of the invention.

Use of the same reference symbols in different figures indicates similar or identical items.

### DETAILED DESCRIPTION

In accordance with an aspect of the invention, a telecentric optical system having a first set of elements adjacent to a transmitter array and a second set of elements adjacent to a receiver array can maintain multiple free-space optical communication channels in alignment for high data rate communications even in a multi-board system that is subject to vibrations and thermal changes. All of the optical signals pass in parallel through focusing optical elements, so that the optical system forms an image of the transmitter array on the receiver array. Telecentricity of the optical system avoids image distortion and provides tolerance that keeps the images of transmitters on photosensitive areas of detectors for a range of separations between the transmitter array and the receiver array. A dynamic alignment control system can move the optical elements to shift the image of the transmitter array perpendicular to the optical axis as required to keep the communication channels aligned despite vibrations and thermal changes in the environment in which the communication channels are maintained.

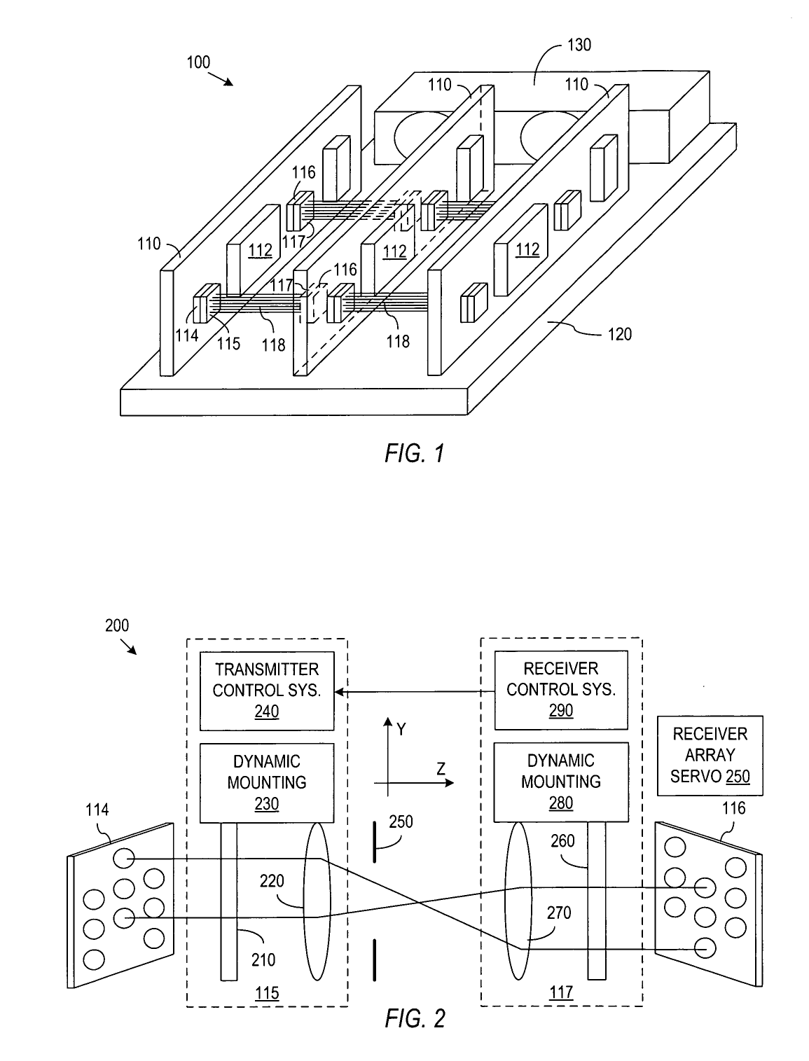

FIG. 1 illustrates a server system 100 employing communication channels in accordance with an embodiment of the invention. System 100 includes a set of blades 110 that are mounted on a shared backplane 120. Additional components 130 such as power supply transformers and cooling fans can also be connected to backplane 120, and the entire assembly would typically be contained in a shared enclosure (not shown). A user interface and sockets for external connections to server system 100 may be provided through the shared enclosure.

Some or all of blades 110 in system 100 may be substantially identical or of differing designs to perform different functions. For example, some blades 110 may be server blades or storage blades. Each blade 110 includes one or more subsystems 112 that implement the particular functions of the blade 110. Subsystems 112 may be mounted on either one or both sides of each blade 110 in the manner of components on a printed circuit board, or blades 110 may include enclosures with subsystems 112 in the interior of the blade 110. Typical examples of such subsystems 112 include hard drives or other data storage and processor subsystems containing conventional computer components such as microprocessors, memory sockets, and integrated circuit memory. Subsystems 112 and the general features of blades 120 may be of conventional types known for server systems using blade architectures, such as the c-class architecture of server systems commercially available from Hewlett-Packard Company.

Each blade 110 additionally includes one or more array of optical transmitters 114 and one or more array of optical receivers 116. Each transmitter array 114 is positioned on a blade 110 to be nominally aligned with a corresponding receiver array 116 on a neighboring blade 110 when the blades 110 are properly mounted on backplane 120. In a typical configuration for server system 100, there may be about 5 cm of free space between corresponding transmitter array 114 and receiver array 116, and each receiver array 116 may be subject to translational misalignment on the order of about 500 to 1000 μm and angular misalignment of up to about 1.5° relative to the associated transmitter array 114 due to variations in the mechanical mounting of blades 110. Additionally, the alignment of transceivers 114 and 116 may be subject to variations on the order of 40 to 50 μm and up to 2° due to fabrication tolerances, temperature variations, and/or mechanical vibrations, for example, from the operation of cooling fans or hard drives.

Each transmitter array 114 includes an array of light sources or emitters such as vertical cavity surface emitting lasers (VCSELs) or light emitting diodes (LEDs) that can be integrated into or on an integrated circuit die. Each light source in array 114 emits a beam 118 that can be modulated independently to encode data for transmission at a high data rate, e.g., about 10 Gb/s.

Each receiver array 116 generally includes an array of detectors, e.g., photodiodes with each photodiode having a light sensitive area of a size selected according to the data rate of the signal received at the photodiode. For a data rate of 10 Gb/s or larger the width of light sensitive area generally needs to be less than about 40 μm across.

An optical system 115 is adjacent to each transmitter array 114. As described further below, at least some of the optical elements in system 115 form a portion of a telecentric lens that is shared by all the optical signals. In one embodiment, optical system 115 is dynamic and includes one or more optical elements in mountings capable of moving the optical elements so that a control system can adjust the direction or position of beams from transmitter array 114. In an alternative embodiment, optical system 115 is fixed during operation, and an optical system 117 associated with the matching receiver array 116 dynamically adjusts during transmissions on the optical data channels to maintain transmitter-receiver alignment. In general, both optical systems 115 and 117 may be dynamic.

An optical system 117 is adjacent to each receiver array 116. Each optical system 117 contains optical elements that when combined with optical elements in the matched optical system 115 forms a telecentric lens, preferably both image side and object side telecentric, and the telecentric lens forms an image of the transmitter array 114 on the receiver array 116. As a result, detectors in the receiver array 116 receive respective optical signals 118 from emitters in the transmitter array 114. The telecentricity provided by a pair of systems 115 and 117 makes the optical communication channels between a transmitter array 114 and a receiver array 116 tolerant of variations in the separation between the transmitter array 114 and the receiver array 116, i.e., tolerant to movement along the optical axis of the telecentric lens.

Optical system 117 may be dynamically adjustable and contain one or more optical elements in mountings capable of moving the optical elements during data transmission through the optical data channels. In general, optical system 117 needs to be dynamically adjustable in embodiments where the corresponding transmitter optical system 115 is fixed, but being dynamically adjustable is optional for optical system 117 in the embodiment where the corresponding transmitter optical system 115 is dynamically adjustable. Control systems in optical system 115 and/or optical systems 117 can be operated to adjust the positions of one or more optical element in optical systems 115 and/or 117. Any established communications established between blades 110 can be used to coordinate dynamic operation of optical systems 115 and 117, for example, to transmit alignment data from the receiver array 114 to a servo control system for optical system 117. The alignment data can, for example, be carried on a lower data rate electrical channel or as part of the data on any optical channel between blades 110. Transmission of alignment data may be unnecessary in embodiments of the invention where optical system 115 is fixed and only optical system 117 performs the dynamic alignment. However, beam control from the transmitter side optical system 115 can provide a geometric advantage that may permit use of smaller (and therefore less expensive) optical elements in optical system 117 than would be required if optical system 117 alone corrected for misalignment.

FIG. 2 shows schematic view of a system 200 providing multiple optical communication channels in accordance with an embodiment of the invention. System 200 includes a transmitter array 114 with an associated optical system 115 and a receiver array 116 with an associated optical system 117 such as described with reference to FIG. 1. Optical system 115 in the embodiment illustrated in FIG. 2 includes a plate 210 and a lens 220 held in an active/dynamic mounting 230. Dynamic mounting 230 is under the control of transmitter control system 240, which determines how to move optical elements 210 and 220 during operation of the optical data channels. Receiver optical system 117 similarly contains a plate 260 and a lens 270 held in an active/dynamic mounting 280, and a receiver control system 290 controls mounting 280 to move optical elements 260 and 270. Provided that arrays 114 and 116 are rotationally aligned, control systems 240 and 290 can move optical elements 210, 220, 260, and 270 to maintain alignment for high data rate optical communications.

Optical systems 115 and 117 cooperate to act as a telecentric lens that forms an image of transmitter array 114 in the plane of receiver array 116. With proper alignment, transmitter array 114 is imaged on receiver array 116 so that light sources in transmitter array 114 coincide with detectors in receiver array 116. FIG. 2 illustrates an example where the pattern of detectors in receiver array 116 is inverted relative to the pattern of light sources in transmitter array 114 because the combined optical systems 115 and 117 invert the image of transmitter array 114. Further, in the exemplary embodiment, the light sensitive areas in receiver array 116 have the same pitch as the light sources in transmitter array 114, and the telecentric lens has unit (i.e., 1×) magnification. Alternatively, the magnification of the telecentric lens can be selected to magnify or reduce the size of the image of transmitter array 114 to match the size of receiver array 116.

The size and magnification of the image of transmitter array 114 does not change significantly with the separation between arrays 114 and 116 because the combined optical system is telecentric. Accordingly, if vibrations or thermal changes cause transmitter array 114 or receiver array 116 to move in the Z direction in FIG. 2, the size of the image of the transmitter array 114 on receiver array 116 does not change. Telecentric lenses are also free of many types of distortion such as field distortion. As a result, the size and spacing of illuminated areas remains constant, and multiple channels will remain aligned as long as the center of the image remains centered on the center of receiver array 116 and the image is rotationally aligned with receiver array 116. The absence or reduction of coma or other distortion reduces cross talk caused by light from one optical signal leaking into the detector for another optical signal. Optionally to further decrease noise or cross-talk, an aperture 250 can be inserted between optical systems 115 and 117, ideally where the focusing effects of optical system 115 cause the optical signals to cross. Separate apertures (not shown) could also or alternatively be provided respectively around the detectors in receiver array 116.

Mountings 230 and 280 move one or more of the optical elements 210, 220, 260, and 270 to align the center of the image of transmitter array 114 with the center of receiver array 116. In the exemplary embodiment, mounting 230 or 280 contains mechanical structure capable of tilting plate 210 or 260 and of shifting lens 220 or 270 in a plane perpendicular to the optical axis of the system, e.g., in an X-Y plane in FIG. 2.

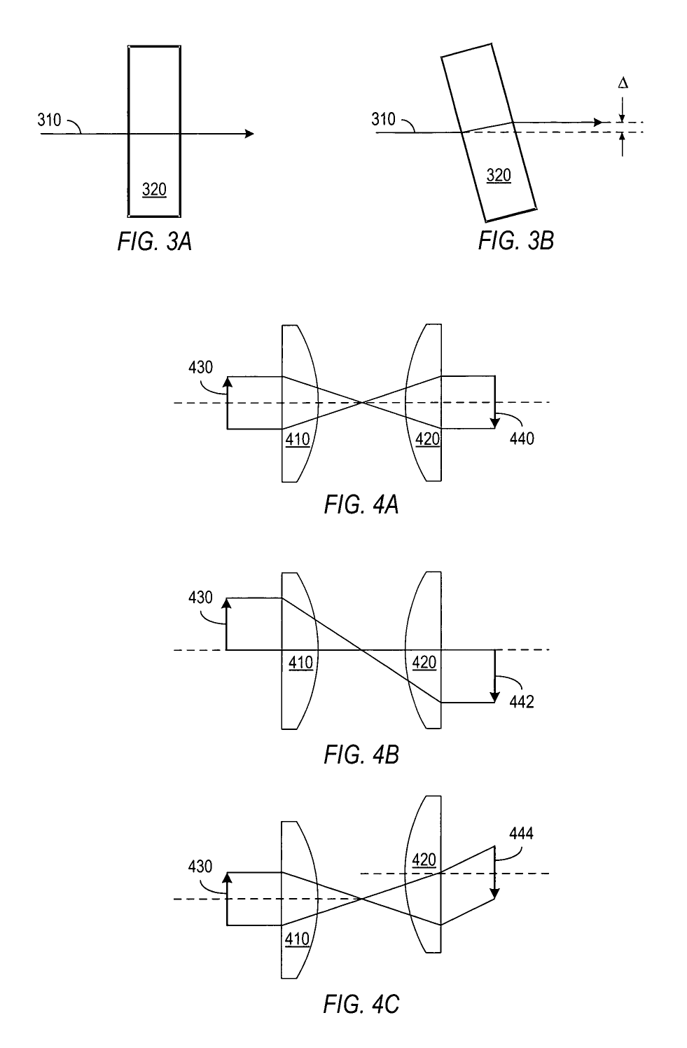

Tilting either plate 210 or 260 shifts the location of the image in the X-Y plane by an amount that depends on the thickness of the plate 210 or 260, the refractive index of the plate 210 or 260, and the magnitude of the tilt. FIGS. 3A and 3B illustrate the effect of tilting a plate relative to the direction of propagation of a light beam. In particular, a beam 310 that is perpendicular to the surfaces of a plate 320 passes directly through plate 320 without deflection as shown in FIG. 3A. When plate is tilted relative to the direction of a beam 315, as shown in FIG. 3B, the beam is deflected by a distance Δ that is about equal to T(1−1/n)sin θ, when plate 320 is tilted by a small angle θ, T is the thickness of the plate, and n is the refractive index of the plate. If mountings 230 and 280 permit tilting plate 210 or 260 about two perpendicular axes, the image of transmitter array 114 can be shifted in any direction in the X-Y plane.

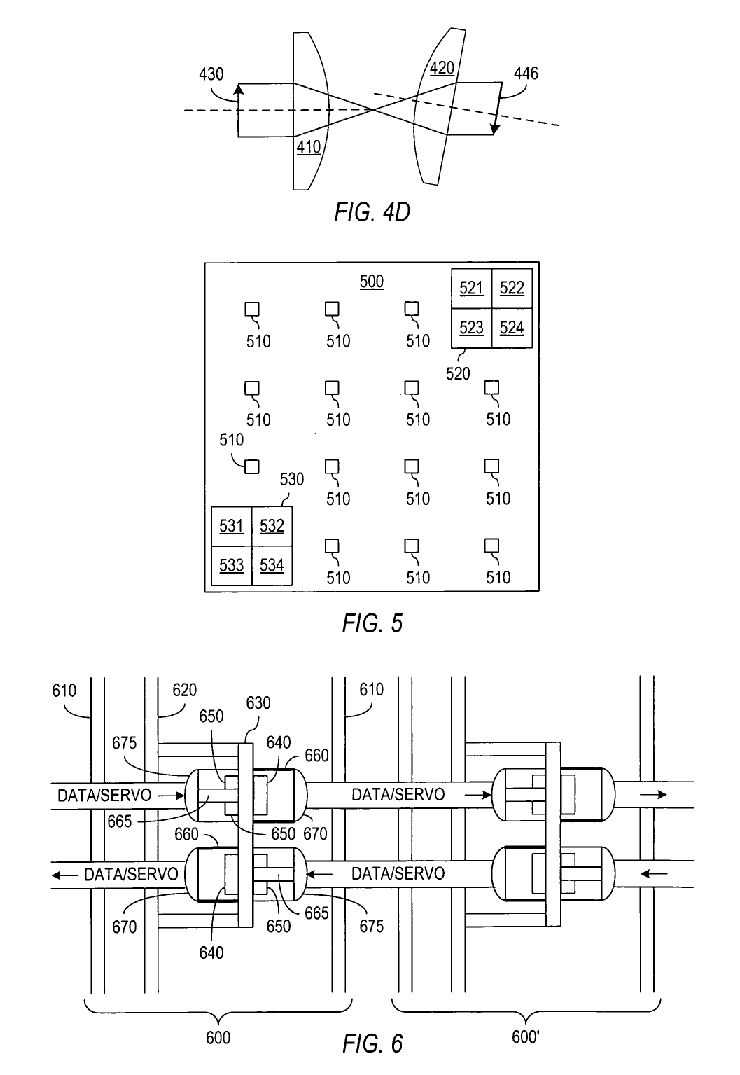

Shifting or tilting one or both lenses 220 and 270 can also shift the image of transmitter array 114. FIGS. 4A, 4B, 4C, and 4D illustrate how shifting a component lens shifts the location of an image. In particular, FIG. 4A shows a configuration where two lenses 410 and 420 have a shared optical axis that passes through the center of an object 430. An image 440 formed by the combination of lenses 410 and 420 is also centered on the shared optical axis of axis of lenses 410 and 420. When one or more lens is translated perpendicular to its optical axis, the image is translated perpendicular to the separation between the lenses. For example, in FIG. 4B, both lenses 410 and 420 are shifted downward an equal amount so that their optical axes remain aligned but pass along a bottom edge of object 430. A resulting image 442 is shifted downward relative to the image 440 of FIG. 4A. More specifically, if object 430 is offset by an amount, Δo, from the optical axis of lenses 410 and 420, image 440 is shifted by a corresponding distance Δi=M Δo, where M is the magnification of the optical system including lenses 410 and 420. For many lens systems, the shift would cause image distortion and coma, but there is no image distortion or coma for the system of FIG. 4B because in a telecentric system, the chief rays from object 430 land normal to the image plane.

FIG. 4C illustrates the effect of one component lens 420, for example, being off axis from the other lens 410. The relative offset of the component lenses 410 or 420 shifts an image 444 in the X-Y plane relative to the object 430 as shown. This effect can be used to correct alignment of the image with the location of the receiver array. For example, if some effect such as angular misalignment of the transmitter and receiver causes the image 440 (FIG. 4A) to be offset from the receiver array, lens 420 (or lens 410) can be shifted relative to the receiver array to shift image 442 into the aligned position. It should be noted however, that the relative offset leaves image 442 centered on the optical axis of lens 420. Accordingly, if a transmitter array is centered on lens 410 and a receiver array is centered on lens 420, the image of the transmitter array will remain on the receiver array, even when the optical axes of lenses are not aligned. The optical system is thus very tolerant of translation offsets between the transmitter and receiver boards. Additionally, the lens system as a whole remains approximately telecentric, so that coma and image distortion are avoided to a high degree.

FIG. 4D illustrates the effect of one lens 420 being tilted relative to the other lens 410. Tilting may result in the server system 100 of FIG. 1, for example, when blades 110 are not parallel to each other, for example, because of fixed differences in the mounting of blades 110 or time varying vibrations of blades 110. As illustrated in FIG. 4D, tilting shifts the location of the image 446 relative to the optical axis of the tilted lens 420. For example, for tilt illustrated in FIG. 4D, image 446 is shifted upward relative to the optical axis of lens 420 by a distance of about f·sin θ, where f is the focal length and θ is the tilt angle of lens 420. In accordance with an aspect of the invention, shifting a lens relative to transmitter or receiver array can compensate for the offset caused by relative tilting and move the image to the aligned position on the receiver array, e.g., to center the image on the optical axis. An optical plate could alternatively be employed for this purpose.

System 200 of FIG. 2 provides many mechanisms for shifting the image of transmitter array 114 for alignment with receiver array 116. In particular, either plate 210 or 260 can be tilted, either lens 220 or 270 can be shifted, or any combination of these movements can be used to shift the image to achieve or maintain alignment. This allows flexibility in the design of servo systems in mountings 230 and 280. For example, large lenses 220 and 270 can be used for better optical quality and easier fabrication and assembly. Movement of the large and heavy lenses 220 and 270 can then be used to compensate larger and lower frequency misalignment, while plates 210 and 260 can be light weight and used to compensate for smaller and higher frequency misalignment. In another configuration, the transmitter side plate 210 and lens 220 could be used to compensate for misalignment along one axis and the receiver side plate 260 and lens 270 can be used to compensate for misalignment along a perpendicular axis. In yet another configuration, all alignment corrections can be performed on one side, e.g., the transmitter side. In still another configuration, plates 210 and 270 can be eliminated entirely while movement of lenses 220 and 260 controls alignment. This design flexibility helps reduce the complexity of the mechanical servo systems in mountings 230 and 280.

Whichever servo mechanisms are employed in a particular embodiment of the invention mountings 230 and 280, control systems 240 and 290 can employ closed loop servo control to electronically measure and correct the misalignment. In one embodiment, the optical power received in the communication channels or in separate alignment channels can be monitored to determine whether the system is misaligned and determine the correction required.

FIG. 5 is a plan view of a receiver array 500 with provisions for analog channels for servo control. Receiver array 500 can be integrated on an integrated circuit die that includes photodiodes with photosensitive areas 510 for receiving optical signals of high data rate digital channels. Additionally, receiver array 500 includes two directional detectors 520 and 530 for system alignment. Directional detector 520 includes four photodiodes with photosensitive areas or quadrants 521, 522, 523, and 524, and directional detector 530 similarly includes four photodiodes with photosensitive areas or quadrants 531, 532, 533, and 534. For the alignment process, a transmitter array paired with receiver array 500 emits two relatively wide cross-section beams intended to be respectively centered on detectors 520 and 530. Misalignment of receiver array 500 and the transmitter array can then be determined from the ratios of the optical power or intensity received in the quadrants 521, 522, 523, and 524 of detector 520 and quadrants 531, 532, 533, and 534 of detector 530. For example, ideal alignment may correspond to a configuration where each of the four quadrants 521, 522, 523, and 524 of detector 520 receives the same amount of power and each of the four quadrants 531, 532, 533, and 534 of detector 530 receives the same amount of power. A servo control system can detect when receiver array 500 is in rotational alignment when the ratios of power received in quadrants 521, 522, 523, and 524 of detector 520 to the power received respectively in quadrant 531, 532, 533, and 534 of detector 530 are equal and can detect that the image of the transmitter array needs to be shifted when the power received in the four quadrants of a detector 520 or 530 are not equal.

FIG. 6 illustrates a server system in accordance with a specific embodiment of the invention. In FIG. 6, a first blade 600 includes a case 610 containing a mother board 620. Case 610 may be metal and would typically be about 50 mm wide in current server systems. Mother board 620 has integrated electronics that implement the function of blade 600. A daughter board 630 mounted on mother board 620 implements the free-space optical communication channels with an adjacent blade 600′ and other blades (not shown). A typical separation between blades 600 and 600′ may be about 50 mm or more, for example, twice as much or 100 mm if the immediately adjacent slot for a blade is unused.

Transmitter arrays 640 and receiver arrays 650 are mounted on daughter board 630 and can communicate with mother board 620 through a high bandwidth board-to-board header. Transmitter array 640 and receiver array 650 may, for example, be laid out in the pattern of receiver array 500 of FIG. 5 and provide 14 high bandwidth (e.g., 10 Gb/s) digital data channels and also optical channels used by servo control systems. Mounting structures 660 and 665 attached to daughter board 630 hold respective lenses 670 and 675 adjacent to transmitter array 640 and receiver array 665, respectively. Lenses 670 and 675 may be plastic lenses such as NT46-373 available from Edmund Optics and when paired together lenses 670 and 675 for a telecentric optical system shared by multiple optical channels, e.g., by servo channels and 14 separate high bandwidth data channels. Each mounting structure 660 or 665 can include flexures and one or more actuators such as piezo or thermal bimorph attached to shift the attached lens 670 or 675 along an axis parallel to daughter board 630. In the embodiment of FIG. 6, mounting structures 660 can move lenses 670, which are associated with transmitters 640, in a direction along the page of FIG. 6, and mounting structures 665 can move lenses 675, which are associated with receiver arrays 650, in a direction perpendicular to the page of FIG. 6. Accordingly, the combination of movements on the transmitter side and the receiver side can provide image shifts in any direction perpendicular to the separation between blades 600 and 600′.

Although the invention has been described with reference to particular embodiments, the description only provides examples of the invention's application and should not be taken as a limitation. For example, embodiments illustrated as including single lens elements may employ compound lenses or other multiple element structures to perform similar functions. Further, although the illustrated examples emphasize applications of embodiments of the invention to servers and particularly between server blades, embodiments of the invention could be employed in other systems and particularly any system employing multiple circuit boards that would benefit from having optical communications between or among the circuit boards. Various other adaptations and combinations of features of the embodiments disclosed are within the scope of the invention as defined by the following claims.

What is claimed is:

1. A system comprising:
a first array coupled to a first subsystem, wherein the first array contains transmitters that respectively produce optical signals that are transmitted through free space to a second subsystem;
a first lens through which the plurality of optical signals pass;
a first mounting system that attaches the first lens to the first subsystem;
a second array coupled to a second subsystem, wherein the second array contains receivers respectively corresponding to the optical signals;
a second lens through which the plurality of optical signals pass, wherein the first lens and the second lens together constitute a telecentric lens that forms an image of the first array on the second array;
a second mounting system that attaches the second lens to the second subsystem, wherein at least one of the first mounting system and the second mounting system dynamically moves the attached lens to maintain the image of the first array in an aligned position on the second array.

2. The system of claim 1, wherein the system comprises a server, the first subsystem comprises a first server blade, the second subsystem comprises a second server blade, and the optical signals are transmitted through free space between the first server blade and the second server blade.

3. The system of claim 1, further comprising a plate attached to the first subsystem by the first mounting system, wherein the first mounting system dynamically tilts the plate to position the image.

4. The system of claim 1, further comprising a plate attached to the second subsystem by the second mounting system, wherein the second mounting system dynamically tilts the plate to position the image.

5. The system of claim 1, further comprising a closed-loop control system that operates at least one of the first mounting system and the second mounting system to dynamically move the attached lens and maintain the image of the first array in an aligned position on the second array.

6. The system of claim 5, wherein the second array further comprises a directional detector used in the close-loop control system.

7. The system of claim 1, wherein the first array comprises an integrated circuit die, wherein the transmitters comprise respective VCSELs fabricated in the integrated circuit die.

8. The system of claim 1, wherein the second array comprises an integrated circuit die, wherein the receivers comprise respective photodiodes contained in the integrated circuit die.

9. The system of claim 8, wherein the second array further comprises a directional detector contained in the integrated circuit die.

10. A method for transmitting data from a first subsystem to a second subsystem, the method comprising:
modulating a plurality of optical signals using a first array in the first subsystem;
transmitting the optical signals through a first optical system at the first subsystem, free space between the first and second subsystems, and a second optical system at the second subsystem to a second array in the second subsystem, wherein the first optical system comprises a first lens through which all of the optical signals pass, the second optical system comprises a second lens through which all of the optical signals pass, and the first lens and the second lens together form a telecentric lens that forms an image of the first array on the second array; and
moving at least one optical element in at least one of the first optical system and the second optical system to align the image with the second array for data transmission.

11. The method of claim 10, wherein the first subsystem comprises a first server blade in a server, and the second subsystem comprises a second server blade in the server.

12. The method of claim 10, wherein moving at least one optical element comprises moving at least one of the first lens and the second lens in a direction perpendicular to its optical axis.

13. The method of claim 10, wherein moving at least one optical element comprises tilting a plate through which all of the optical signals pass.

14. A system comprising:
a first circuit board;
a first array mounted on the first circuit board, wherein the first array contains transmitters that respectively produce first optical signals that are transmitted from the first circuit board and through free space;
a first lens through which the first optical signals pass; and
a first mounting system that attaches the first lens to the first circuit board, wherein the first mounting system comprises:
first flexures that hold the first lens and permit the first lens to move in a first direction perpendicular to an optical axis of the first lens; and
a first actuator operable to move the first lens in the first direction.

15. The system of claim 14, further comprising:
a second circuit board;
a second array mounted on the second circuit board, wherein the second array contains receivers respectively corresponding to first optical signals;
a second lens through which the first optical signals pass, wherein the first lens and the second lens together constitute a telecentric lens that forms an image of the first array on the second array; and
a second mounting system that attaches the second lens to the second circuit board, wherein the second mounting system comprises:
second flexures that hold the second lens and permit the second lens to move in a second direction perpendicular to the first direction and to an optical axis of the second lens; and
a second actuator operable to move the second lens in the second direction.

16. The system of claim 14, further comprising:
a second array mounted on the first circuit board, wherein the second array contains receivers respectively corresponding to a plurality of second optical signals that arrive at the first circuit board;
a second lens through which the second optical signals pass; and
a second mounting system that attaches the second lens to the circuit board, wherein the second mounting system comprises:
second flexures that hold the second lens and permit the second lens to move in a second direction perpendicular to the first direction and to an optical axis of the second lens; and
a second actuator operable to move the second lens in the second direction.

17. The system of claim 14, wherein the first actuator comprises a bimorph.
